(19) United States
(12) Patent Application Publication
(10) Pub. No.: US 2005/0207392 A1
(43) Pub. Date: Sep. 22, 2005

(54) Higher layer packet framing using RLP

(75) Inventors: Sanjeevan Sivalingham, San Diego, CA (US); Srinivasan Balasubramanian, San Diego, CA (US)

Correspondence Address: COATS & BENNETT, PLLC, P O BOX 5, RALEIGH, NC, 27602, US

(73) Assignee: Telefonaktiebolaget LM Ericsson (publ)

(21) Appl. No.: 11/084,888

(22) Filed: Mar. 21, 2005

Related U.S. Application Data
(60) Provisional application No. 60/554,620, filed on Mar. 19, 2004.

(51) Int. Cl. H04J 3/24

(52) U.S. Cl. 370/349

(57) ABSTRACT

Higher layer packet (HLP) framing information is transmitted across the air interface only as necessary, utilizing the Radio Link Protocol (RLP). In one embodiment, a new RLP control frame is transmitted between RLP data frames containing data from different HLP, demarking the boundary between the HLP. In another embodiment, a new RLP data frame contains framing information, and an indicator of that framing information. The new RLP data frame is transmitted only when necessary, e.g., when the RLP data frame includes a HLP boundary. When transmitting intermediate HLP fragments, conventional RLP data frames are used, wherein the entire payload is dedicated to user data, and the framing information is transmitted implicitly.

### RELATED APPLICATIONS

This application claims priority to Provisional U.S. Patent Application 60/554,620 filed Mar. 19, 2004, which is incorporated herein by reference.

### BACKGROUND

The present invention relates generally to the field of wireless communication networks and in particular to a method of communicating the boundaries of higher layer data packets using the Radio Link Protocol (RLP).

The 3rd Generation (3G) wireless communication networks provide mobile users wireless access to packet data networks, such as the Internet. Many Internet applications and services, once available only to users at fixed terminals, are now being made available via wireless communication networks to mobile users. Services such as real-time streaming video and music, on-line interactive gaming, text messaging, email, web browsing and Voice over IP (VoIP), or Push-to-Talk (“walkie talkie” functionality) are just a few examples of services now being provided via wireless networks to mobile users.

These services are characterized by packet-switched data transfer, in which data is encapsulated into a logical unit called a packet, which contains a source and destination address and is routed from source to destination along nodes in one or more networks. Many data packets may be transmitted together on shared wireless traffic channels, with each mobile station retrieving only data packets addressed to it. This mode of data transfer is distinguished from the traditional circuit-switched paradigm of early-generation wireless voice communications, wherein a wireless traffic channel was dedicated to each individual call, or voice conversation. Packet-switched data transfer is generally more flexible and allows for more efficient utilization of network resources, than circuit-switched data transfer. However, data packets may also be transmitted on dedicated traffic channels.

According to some modern wireless communication network standards, a Packet Data Service Node (PDSN) within the network interfaces to external packet-switched data networks, such as the Internet, and effects Internet Protocol (IP) packet data communication between these external networks and the Radio Access Network (RAN) of the wireless system. Within the RAN, a Base Station Controller (BSC) eventually receives packet data forwarded by the PDSN, and directs it to individual mobile stations in radio contact with one or more Radio Base Stations. Packets are also communicated in the reverse direction, from a mobile station to an external network node.

On the wireless network side of the PDSN, under some current network standards a Point-to-Point Protocol (PPP) is established between the PDSN and the mobile station. The PPP protocol uses a High-level Data Link Control (HDLC) protocol link layer. The HDLC service encapsulates higher layer packets (HLP) into data link layer frames. The frames are separated by HDLC flags, or unique bit sequences that delimit the beginning and end of a frame. To prevent data within the frame, which may have the same bit sequence as a flag, from causing erroneous frame boundary determinations, flag-matching bit sequences within the HDLC frame payload are escaped and modified. That is, a second unique bit sequence, the escape sequence, is inserted, and the flag-matching bit pattern is modified, such as by XOR with a predetermined value. Any occurrence in the data of the escape sequence itself is also escaped and modified. This protocol makes the HDLC frame “transparent,” in that any sequence of data bits may be reliably transmitted.

At the receiver, each octet in the frame is inspected, and the data between two occurrences of the flag bit sequence are determined to comprise the HDLC frame. Additionally, the frame data is searched for the escape sequence. If found, the escape sequence is removed, and the following octet is XORed with the predetermined value, restoring the data to its original state. This need to inspect each and every received octet to detect either a frame-delimiting flag or an escape sequence is processor-intensive. The task may be delegated to hardware; however, this would impose a new requirement on equipment manufacturers, and require an upgrade of fielded equipment. An additional drawback of the HDLC framing protocol is that each occurrence of the escape sequence must be transmitted across the air interface, only to be removed by the receiver. This wastes scarce air interface resources.

In the Broadcast/Multicast Services (BCMCS) architecture, PPP, and hence, HDLC, is not utilized. In BCMCS, the framing protocol takes advantage of the traffic channel frame structure to transmit information regarding higher layer packet (HLP) framing. In particular, the framing protocol at the transmitter utilizes a predetermined number of bits at the beginning of the data in each Multiplexing Sublayer Protocol Data Unit (MuxPDU) to pass higher layer framing information. The bits indicate whether the data in the MuxPDU comprise a fragment of a HLP or a complete HLP. In the case of a fragment, the bits further indicate whether the fragment is from the beginning, middle or end of the HLP.

In the case where the MuxPDU is of a fixed size (e.g., BCMCS over a High-Rate Packet Data channel), a length field is also included at the beginning of the data in each MuxPDU. The length field indicates how much of the data in the fixed-size MuxPDU belongs to a particular HLP. Data from another HLP (with framing information bits included) or perhaps padding is added to fill the MuxPDU. In the case of a variable-size MuxPDU (e.g., BCMCS over CDMA2000-1X), the data in each MuxPDU contains only bits indicating framing information. No length information is included, as the MuxPDU header provides this information.

The receiver examines the beginning of the data in each MuxPDU received. It utilizes the framing information bits to determine whether the payload contains a complete HLP or a fragment of a HLP. In the case of fragments, the receiver utilizes the framing bits to re-assemble the HLP from data transmitted in multiple MuxPDUs. In the case of fixed-size MuxPDUs, the receiver also utilizes the length information bits to determine how much of the data in the MuxPDU belongs to a particular HLP. Since the framing and length (when present) information are positioned at the beginning of the data in each MuxPDU, the receiver can obtain this information efficiently, without having to parse all received data octets, as required in HDLC.

Although the BCMCS framing method is less processor-intensive than HDLC, it requires framing and length information to be sent in the data payload of every MuxPDU. For packet data services where RLP is utilized, the inclusion of the framing and length information results in at least one octet of RLP payload (or possibly more, depending on of the size of the length field) not being available to carry actual data, since the RLP payload consists of integer number of data octets. In many cases, the framing and length information in several of the RLP frames/MuxPDUs is redundant, as the same information is carried in several consecutive RLP data frames/MuxPDUs. For example, where the HLP spans several RLP data frames, all of the RLP data frames carrying data from the middle of the HLP (i.e., not the beginning or the end) carry the same framing information. This may occur, for example when a large HLP is being transmitted with a low data rate assigned to the air interface channel.

Framing methods that avoid the inefficiencies of HDLC framing will be necessary for the evolution of the CDMA2000 Packet Data Architecture. The BCMCS framing approach is an improvement over HDLC, but still consumes air interface resources to transmit framing and packet length information. Optimally, these resources should be reserved for user data to the maximum extent possible.

### SUMMARY

According to various embodiments of the present invention, higher layer packet (HLP) framing information is transmitted across the air interface only as necessary, utilizing the Radio Link Protocol (RLP). In one embodiment, a new RLP control frame is transmitted between RLP data frames containing data from different HLP, demarking the boundary between the HLP. In another embodiment, a new RLP data frame contains framing information, and an indicator of that framing information. The new RLP data frame is transmitted only when necessary, e.g., when the RLP data frame includes a HLP boundary. When transmitting intermediate HLP fragments, conventional RLP data frames are used, wherein the entire payload is dedicated to user data, and the framing information is transmitted implicitly.

### BRIEF DESCRIPTION OF DRAWINGS

FIG. 1 is a functional block diagram of a wireless communication network.

FIG. 2 is a network layer framing diagram depicting the use of RLP control frames to transmit higher layer packet boundary information.

FIG. 3 is a network layer framing diagram depicting the use of RLP data frames to implicitly or explicitly transmit higher layer packet boundary information.

### DETAILED DESCRIPTION

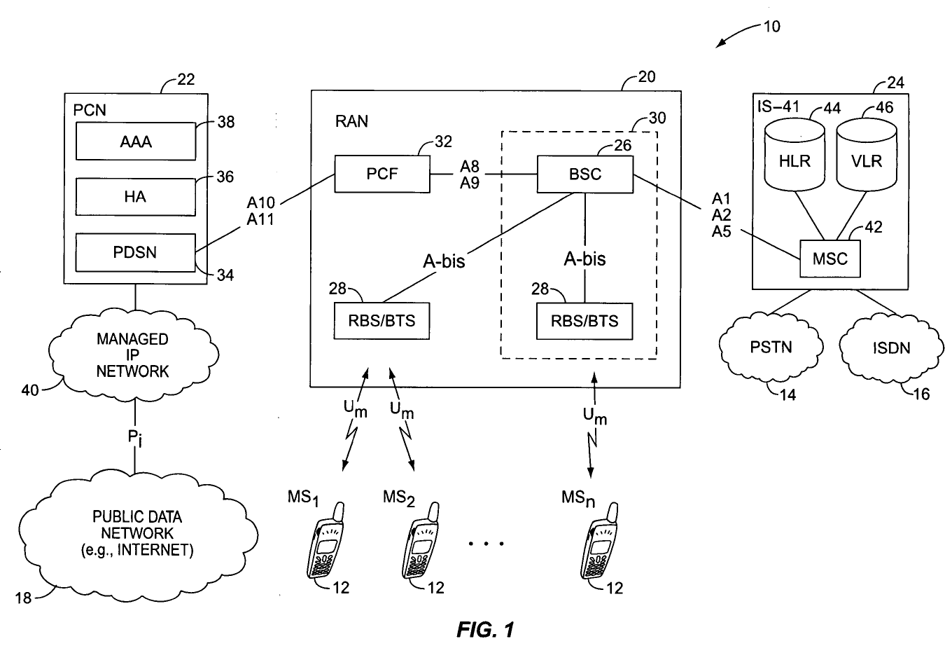

FIG. 1 illustrates an exemplary wireless communication network generally referred to by the numeral 10. The wireless communication network 10 may be any type of wireless communication network, such as a CDMA network, WCDMA network, GSM/GPRS network, EDGE network, or UMTS network. In one exemplary embodiment, network 10 is based on cdma2000-1x standards as promulgated by the Telecommunications Industry Association (TIA), although the present invention is not limited to such implementations. Here, network 10 communicatively couples one or more mobile stations 12 to another mobile station 12, or to the Public Switched Telephone Network (PSTN) 14, the Integrated Data Services Network (ISDN) 16, and/or a Public Data Network (PDN) 18, such as the Internet. In support of this functionality, the network 10 comprises a Radio Access Network (RAN) 20 connected to a Packet Core Network (PCN) 22 and an IS-41 network 24.

The RAN 20 typically comprises one or more Base Station Controllers (BSCs) 26, each connected to one or more Radio Base Stations (RBS) 28 via an A-bis interface. Each RBS 28 (also known in the art as a Base Transceiver Station, or BTS) includes the transceiver resources (not shown) supporting radio communication with mobile stations 12, such as modulators/demodulators, baseband processors, radio frequency (RF) power amplifiers, antennas, etc. The combination of a BSC 26 and a RBS 28 form a Base Station (BS) 30. Note that a given BSC 26 may be part of more than one BS 30. In operation, a BS 32 transmits control and traffic data to mobile stations 12 on forward link channels, and receives control and traffic data from the mobile stations 12 on reverse link channels.

The BSC 26 is communicatively coupled to the PCN 22 via a Packet Control Facility (PCF) 32. The BSC 26 connects to the PCF 32 over an A8 interface carrying user traffic and an A9 interface carrying signaling. The PCF 32 manages the buffering and relay of data packets between the BS 30 and the PCN 22. As those of skill in the art will recognize, the PCF 32 may be part of the BSC 26, or may comprise a separate network entity.

The PCN 22 comprises a Packet Data Serving Node (PDSN) 34, a Home Agent (HA) 36, and an Authentication, Authorization, and Accounting (AAA) server 38. The PCN 22 may couple to the PDN 18 through a managed IP network 40, which operates under the control of the network 10. The IP network 40 connects to the PDN 18 via a Pᵢ interface, or alternatively another industry standard packet data communication protocol, such as Transport Control Program/Internet Protocol (TCP/IP). Alternatively, the PCN 22 may couple directly to the PDN 18, such as the Internet.

The PDSN 34 provides packet routing services, maintaining routing tables and performing route discovery. The PSDN 34 additionally manages the Radio-Packet (R-P) interface and Point-to-Point Protocol (PPP) sessions for mobile users, assigning authenticated mobile stations 12 an IP address from a pool of addresses. The PSDN 34 additionally frames data such as Broadcast/Multicast Services (BCMCS) media streams for transmission across the RAN to the BS 30 for transmission to one or more mobile stations 12. The PSDN 34 also provides Foreign Agent (FA) functionality for registration and service of network visitors, and initiates authentication procedures with the AAA server 38. The PSDN is communicatively coupled to the PCF 32 via an A10 interface for user traffic and an A11 interface for signaling. HA 36 operates in conjunction with PDSN 34 to authenticate Mobile IP registrations and to maintain current location information in support of packet tunneling and other traffic redirection activities. The AAA server 38 provides authentication, authorization and accounting services for the PSDN 34.

The BSC 26 may also communicatively couple the RAN 20 to an IS-41 network 24. The IS-41 network 24 includes a Mobile Switching Center (MSC) 42 accessing a Home Location Register (HLR) 44 and Visitor Location Register (VLR) 46 for subscriber location and profile information. The MSC 42, coupled to the BSC 26 via an A1 interface for signaling and A2/A5 interface for user traffic, switches circuit-mode traffic between mobile stations 12 and the PSTN 16 and ISDN 14, and provides processing and control for calls and services.

According to one or more embodiments of the present invention, the Radio Link Protocol (RLP) is utilized to transmit the faming, or packet boundary, information of higher layer packets (HLP) between a BS 30 and a mobile station 12, while optimizing the use of air interface resources to transmit user data.

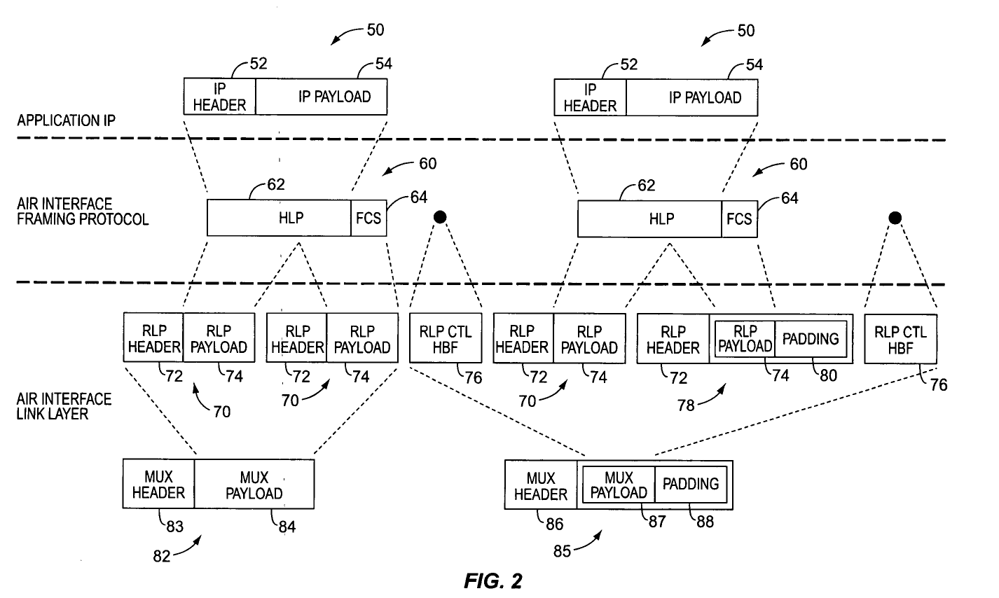

FIG. 2 depicts a network layer diagram, showing the successive encapsulation of HLP 50 into lower level Protocol Data Units (PDUs), using the RLP to transmit HLP framing information, according to one embodiment. An HLP 50, such as for example an IP packet, comprises a header 52 and a payload 54 carrying user data. An Air Interface Framing Layer creates Frame Check Sequence Protocol Data Units (FCS PDUs) 60, by appending a Frame Check Sequence (FCS) 64 to the HLP 62. The FCS 64 allows the Framing Layer in the receiving node to perform validity checks after a complete FCS PDU 60 has been reassembled, in order to detect loss or corruption of data within the FCS PDU 60 during transmission.

In one embodiment, each FCS PDU 60 may be encapsulated in one or more Air Interface Framing Layer Protocol Data Units (AFL PDU) (not shown) by appending an AFL header to the FCS PDU 60. The AFL header may comprise START and END bits that encode whether a beginning fragment (1,0), a middle fragment (0,0), and ending fragment (0,1) or an entire FCS PDU 60 (1,1) are encapsulated in the AFL PDU. Furthermore, in one embodiment, one or more AFL PDUs may be encapsulated into one or more Air Interface Framing Layer Logical Transmission Unit (AFL LTU) (not shown), by appending an LTU INFO field containing information about the length of the AFL PDU to the AFL PDU. The LTU INFO information allows the Framing Layer in the receiving node to determine the position and size of each AFL PDU within the received AFL LTU.

As shown in FIG. 2, the FCS PDU 60 (regardless of whether it has been further encapsulated into an AFL PDU or AFL LTU) is encapsulated into one or more RLP data frames 70. As known in the art, the RLP data frame 70 comprises an RLP header 72 and an RLP payload 74 containing user data. The RLP header 72 includes a sequence number to ensure correct ordering of RLP data frames 70 at the receiver, and that all RLP data frames 70 have been received. The RLP protocol provides a negative acknowledgement procedure for the receiver to acknowledge receipt of sequential RLP data frames 70, and for the transmitter to re-transmit RLP data frames 70 that were not received.

According to one embodiment of the present invention, the boundary of a FCS PDU 60 is communicated to the receiver by transmitting a special RLP control frame, referred to herein as a HLP Boundary Frame (HBF) 76. The HBF 76 is an RLP control frame having the same syntax as an RLP Idle frame. The CTRL field of the HBF 76 is set to the value 0b1011 to indicate to the receiver that it is a HBF 76, and that it demarks the boundary of a higher layer data frame, such as a FCS PDU 60. The sequence number of the HBF 76 is set to the sequence number of the RLP data frame 70 carrying the last part of the higher layer frame 60. The RLP data frames 70, 78 and RLP HBFs 76 are encapsulated in MuxPDUs 82, each comprising a header 84 and payload 86, and transmitted to a receiver node.

A HBF 76 is sent immediately following the last RLP data frame 70 containing part of a higher layer frame 60. After decapsulation from received MuxPDUs 84, the receiver collects all the RLP frames 70 between two HBFs 76 (by sequence number) and assembles the data into a higher layer frame 60 to provide to the Framing Layer in the receiver. The receiver may, for example, extract the HLP 62 and FCS 64 from an assembled FCS PDU 60, and use the FCS to check for errors. If the FCS PDU 60 were encapsulated into AFL PDU and/or AFL LTU structures prior to transmission over the RLP, the receiver Framing Layer would decapsulate these structures as well, using the HBFs 76 to mark data frame boundaries.

Because the receiver assembles all received RLP data frames 70 between HBFs 76 into higher layer data frames, each RLP data frame 70 can contain data from only one higher layer data frame, such as a FCS PDU 60. That is, data from different FCS PDUs 60 cannot be concatenated within a single RLP data frame 70. In some embodiments, padding 80 may be added to an RLP data frame 78, such as by the BSC 26, for circuit switched channels. In other embodiments, padding 88 may be added to a MuxPDU 84, such as by the RBS 28, for packet switched channels.

The method of transmitting higher layer frame boundary information via HBFs 76 in the RLP is referred to herein as “RLP control framing assistance.” This method reduces the number of overhead bits required, as compared to either the HDLC framing method or that utilized by BCMCS. This technique is particularly efficient when the size of the higher layer frames are large enough that they span several RLP data frames, and variable-size MuxPDUs 82 are utilized. For a small HLP and fixed-size MuxPDU 78, since only one higher layer frame 60 may be encapsulated in each RLP data frame 70, the RLP data frame 70 may be smaller than the MuxPDU 78, requiring padding 88 that negates the overhead savings.

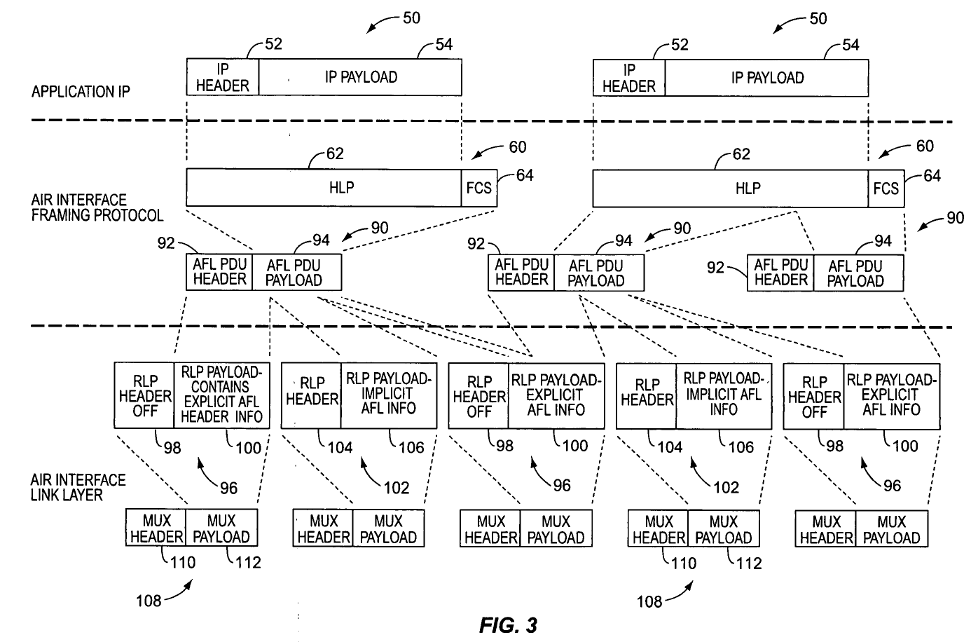

According to another embodiment of the present invention, as depicted in FIG. 3, modified RLP data frames 96 are employed to selectively send explicit higher layer frame boundary information, with implicit boundary information sent in conventional RLP data frames 102. This optimizes utilization of the air interface, inserting framing information bits only when necessary to signal a frame boundary to the receiver. In this embodiment, there is no restriction on the number of FCS PDUs 60 that may be encapsulated into an RLP data frame 96, 102 (or MuxPDU 108). Additionally, either fixed-size or variable-size MuxPDUs 108 may be utilized. This allows for greater efficiency in the use of air interface resources, by eliminating the need to extensively pad RLP data frames 78 or MuxPDUs 84 (FIG. 2).

In this embodiment, each FCS PDU 60 may be encapsulated in one or more AFL PDUs 90. An AFL header 92 comprising START and END bits is appended to an AFL payload 94 comprising a complete FCS PDU or a fraction of a FCS PDU. The START and END bits encode the FCS PDU fragmentation according to the following table:

TABLE 1
AFL Header encoding and RLP data frame type

| START | END | AFL framing information | RLP data frame |
|---|---|---|---|
| 1 | 0 | start of fragmented AFL PDU | explicit |
| 0 | 0 | intermediate portion of | explicit or implicit |
| | | fragmented AFL PDU | |
| 0 | 1 | end of fragmented AFL PDU | explicit |
| 1 | 1 | non-fragmented (complete) | explicit |
| | | AFL PDU | |

As Table 1 also depicts, the RLP data frame that encapsulates the AFL PDUs 90 may transmit framing information explicitly or implicitly. Framing information may be transmitted implicitly in the case of intermediate portions of fragmented AFL PDUs 90, by utilizing conventional RLP data frames 102. That is, the RLP data frame header 104 does not include an ALF INFO indicator, and the RLP data frame payload 106 contains no explicit framing information; the receiver assumes that the entire payload 106 is user data to be decapsulated and passed to a higher protocol layer.

To transmit explicit AFL framing information, such as in the case of AFL PDU framing boundaries (i.e., the beginning or end of an AFL PDU 90, or both in the case of a non-fragmented AFL PDU 90), a new RLP data frame 96 is defined. The new RLP data frame 96 includes an AFL INFO indicator. The AFL INFO indicator may be in the RLP header 98, as indicated in FIG. 3, or may alternatively be in an extended RLP header embedded in the RLP payload 100, as known in the art. The ALF INFO indicator may assume at least two values, referred to herein as ON and OFF.

When the AFL INFO indicator is ON, it indicates to the peer RLP receiver that the current RLP data frame 96—and all RLP data frames 96 to follow (by sequence number) until a contrary AFL INFO indication—contain explicit AFL framing information, such as the START and END bits of the ALF header 92. An RLP data frame 96 with the AFL INFO indicator set to ON places the receiver in a state or mode in which it will search each subsequent RLP data frame 96 for explicit framing information. Conventional RLP data frames without an ALF INFO indicator in the header or extended header may follow an ON RLP data frame 96; these RLP data frames will each contain explicit framing information.

When the AFL INFO indicator is OFF, it indicates to the peer RLP receiver that the current RLP data frame 96 contains explicit AFL framing information; however, no following RLP data frames 102 (by sequence number) will contain explicit AFL framing information. An RLP data frame 96 with the ALF INFO indicator set to OFF removes the receiver from the state or mode of searching each subsequent RLP data frame 102 for explicit framing information. An RLP data frame with the AFL INFO indicator set to OFF may also be utilized to transmit explicit framing information when the receiver is in the OFF state.

This method of transmitting higher layer frame boundary information via RLP data frames 96 containing explicit framing data is referred to herein as “RLP data framing assistance.” Using this method, multiple ALF PDUs 90 (hence multiple FCS PDUs 60), or fragments thereof, may be encapsulated in a single RLP data frame 96. This allows for efficient use of air interface resources when transmitting short HLP 50, eliminating the need to pad RLP data frames 96, 102 or MuxPDUs 108. In this case, an RLP data frame 96 with the AFL INFO indicator ON may set the receiver in a mode to extract explicit framing information from each received RLP data frame 96.

In a situation where large HLP 50 are being transmitted, the corresponding AFL PDUs 90 will be encapsulated across numerous RLP data frames 96, 102. In this case, air interface resources may be further conserved by only transmitting framing information where necessary—i.e., at the AFL PDU boundaries, as depicted in FIG. 3. An initial RLP data frame 96 is transmitted, with the AFL INFO indicator OFF, informing the receiver that the current RLP payload 100 contains explicit framing information (the beginning of an AFL PDU 90), but subsequent RLP data frames 102 will not. The intermediate fragments of the ALF PDU 90 are transmitted in conventional RLP data frames 102, with no explicit framing information. That is, the entire RLP payload 102 carries user data, and the receiver will assemble the entire RLP payload 102 into an AFL PDU 90 to pass to a higher protocol layer. The framing information—that the RLP payload 102 is an intermediate fragment of an AFL PDU 90—is implicit, and no air interface resources are consumed to transmit this information.

When the ALF PDU 90 terminates, the transmitter may utilize another RLP data frame 96 containing explicit framing information to indicate this fact. If following AFL PDU 90 is long and will span plural RLP data frames 102, the explicit RLP data frame 96 may set the AFL INFO indicator to OFF, indicating that only that RLP data frame 96 includes framing information. Conversely, if following AFL PDUs are short and each RLP data frame 96 will contain AFL PDU boundaries, the transmitter may set the receiver to a mode of expecting framing information in each RLP data frame 96 by setting the AFL INFO indicator to ON. In this manner, explicit or implicit framing information may be selectively transmitted in the RLP data frames 96, 102 in response to the RLP encapsulation. This maximizes efficiency by only consuming air interface resources to explicitly indicate framing information where necessary.

Under either method disclosed above—RLP control framing assistance or RLP data framing assistance—the RLP may additionally assist the framing layer in the receiver to reconstruct HLP. Each RLP data frame includes a sequence number. The framing layer in the receiver may receive frame boundary information from the RLP by one of the methods disclosed herein, and may utilize RLP sequence numbers to ascertain if any intervening portions of the HLP are missing. If so, the framing layer may discard the beginning and ending segments, and request retransmission or other error handling mechanism via higher level protocols. In the case that a HLP includes information to perform this error-checking (such as, for example, the FCS field of a BCMCS frame), the error-checking information may be omitted, further optimizing utilization of air interface resources.

Which method of HLP framing information transmission to utilize—HDLC, BCMCS, RLP control framing assistance, or RLP data framing assistance—may depend on several factors. Some of these are consistent, e.g., HDLC always imposes higher processor loading, due to the requirement that each octet be inspected for frame boundary and/or escape characters. Other factors vary from application to application and over time, such as, e.g., the traffic type and available bandwidth. In some embodiments, the framing protocols may be statically determined; in other embodiments, they may be dynamically selected.

By way of non-limiting examples, fixed-rate video is generally transmitted at 24 Kb/sec in fixed size packets. Framing information for this type of traffic may optimally be transmitted by RLP data framing assistance, which minimizes the framing overhead content of the RLP data load. On the other hand, variable rate video is characterized by fluctuations in both data rate and packet size, as the amount of data transmitted varies according to the inter-frame motion in the video content. In some cases, HDLC may be the preferred HLP framing transmission protocol for variable rate video, as it is one continuous octet stream.

As discussed above, RLP control framing may be preferred when the HLP are very large, such as certain types of data file transmission, since the framing information is in control frames and the RLP data frames may be dedicated to user data. Where HLP are short, such as HTTP transmissions common in web browsing applications, the restriction of one HLP per RLP data frame of RLP control framing assistance may require excessive padding of RLP data frames and/or MuxPDUs; in these applications, RLP data framing assistance may be preferred. In some embodiments, the RLP framing assistance method may be dynamically switched based on inspection of the HLP properties, by RLP control frames or other transmitter/receiver communication at the RLP level.

Generally speaking, the RLP framing assistance methods are preferred over HDLC and BCMCS in low bandwidth environments, as they dedicate more payload octets to user data and less to framing information overhead. However, switching in and out of the HDLC and BCMCS protocols generally requires higher level signaling between the framing layers at the transmitter and receiver. Consequently, the ability to dynamically switch between these framing protocols and the RLP framing assistance methods may be constrained.

Those of skill in the art will recognize that the specific embodiments disclosed and discussed herein are exemplary only. In particular, the present invention does not depend on the encapsulation of HLP into FCS PDUs or AFL PDUs, nor are other framing layer encapsulations (such as, for example, the encapsulation of AFL PDUs into AFL LTUs) precluded by the present invention. According to the present invention, any higher layer data structure (whether denoted as a packet, frame, or otherwise) may advantageously be transmitted using the RLP to transmit the framing information, as disclosed herein. The specific examples disclosed and depicted in the drawing figures are utilized to place the present invention in context and to facilitate understanding by those of skill in the art; however the present invention is not limited to any such context, and is limited only by the following claims.

Furthermore, although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

1. A method of transmitting one or more Higher Layer Packets (HLP) in a wireless communication network utilizing the Radio Link Protocol (RLP), comprising:
encapsulating a HLP into RLP data frames;
transmitting the RLP data frames to a receiver; and
transmitting the HLP boundary information in one or more RLP control frames or RLP data frame headers.

2. The method of claim 1 further comprising encapsulating the HLP into one or more lower layer data structures prior to encapsulation into RLP data frames.

3. The method of claim 1 wherein encapsulating the lower level protocol data units into RLP data frames comprises encapsulating data from only one HLP into each RLP data frame, and wherein transmitting HLP boundary information comprises transmitting a RLP Boundary Frame (RBF) after the last RLP data frames carrying data from the HLP.

4. The method of claim 3 wherein the RBF is an RLP control frame with a CTL field value of 0b1011.

5. The method of claim 1 wherein encapsulating the HLP into one or more lower RLP data frames comprises including in the header of at least one RLP data frame an indicator indicating the inclusion of HLP boundary information in the payload.

6. The method of claim 5 wherein the RLP header comprises an extended header defined in the RLP payload.

7. A method of transmitting one or more Higher Layer Packets (HLP) in a wireless communication network utilizing the Radio Link Protocol (RLP), comprising:
receiving one or more HLP;
encapsulating data from the HLP into one or more RLP data frames;
transmitting the RLP data frames over an air interface to a receiver; and
after transmitting all data from each HLP, transmitting a HLP Boundary Frame (HBF) to the receiver.

8. The method of claim 7 wherein each RLP data frame includes data from only one HLP.

9. The method of claim 7 further comprising encapsulating the RLP data frames and HBF into Multiplexing Sublayer Protocol Data Units (MuxPDU) prior to transmitting to the receiver.

10. The method of claim 7 further comprising encapsulating the HLP in a Frame Check Sequence Protocol Data Unit (FCS PDU) prior to encapsulation in RLP frames.

11. The method of claim 7 wherein the HBF is an RLP control frame with a CTL field value of 0b1011.

12. A method of receiving one or more Higher Layer Packets (HLP) in a wireless communication network utilizing the Radio Link Protocol (RLP), comprising:
receiving one or more RLP data frames, each including a sequence number;
receiving at least one HLP Boundary Frame (HBF) including a sequence number; and
in response to the HBF and the sequence numbers, assembling the received data into a HLP, and passing the HLP to a higher layer protocol.

13. The method of claim 12 further comprising receiving one or more Multiplexing Sublayer Protocol Data Units (MuxPDU) and extracting the RLP data frames from the MuxPDU.

14. The method of claim 12 further comprising assembling the received data into a Frame Check Sequence Protocol Data Unit (FCS PDU), and decapsulating the HLP from the FCS PDU.

15. The method of claim 14 further comprising examining an FCS field of the FCS PDU and determining whether the FCS PDU has been received without error.

16. The method of claim 15 further comprising decapsulating an Air Interface Framing Protocol Data Unit (AFL PDU) from the FCS PDU, and decapsulating the HLP from the AFL PDU.

17. The method of claim 12 further comprising discarding the HLP if the RLP sequence numbers indicate that part of the HLP was not received.

18. A method of transmitting one or more Higher Layer Packets (HLP) in a wireless communication network utilizing the Radio Link Protocol (RLP), comprising:
receiving one or more HLP;
encapsulating data from the HLP into one or more Air Interface Framing Layer Protocol Data Units (AFL PDU), each AFL PDU including AFL header information indicating the boundaries of the HLP;
encapsulating data from the AFL PDU into one or more RLP data frames comprising a header and a payload, at least one RLP data frame including an AFL Info indicator in the header indicating whether the current or future RLP data frames include AFL header information indicating the boundaries of the HLP; and
transmitting the RLP data frames over an air interface to a receiver.

19. The method of claim 18 wherein the AFL Info indicator assumes a first value indicating that the current RLP data frame, and additionally succeeding RLP data frames with larger sequence numbers, include AFL header information indicating the boundaries of the HLP.

20. The method of claim 18 wherein the AFL Info indicator assumes a second value indicating that the current RLP data frame includes AFL header information indicating the boundaries of the HLP, but that succeeding RLP data frames with larger sequence numbers will not include AFL header information indicating the boundaries of the HLP.

21. The method of claim 18 wherein at least portions of two or more HLP are encapsulated in the same RLP data frame.

22. The method of claim 18 further comprising encapsulating the RLP data frames into Multiplexing Sublayer Protocol Data Units (MuxPDU) prior to transmitting to the receiver.

23. The method of claim 18 further comprising encapsulating the AFL PDU in a Frame Check Sequence Protocol Data Unit (FCS PDU) prior to encapsulation in RLP data frames.

24. A method of receiving one or more Higher Layer Packets (HLP) in a wireless communication network utilizing the Radio Link Protocol (RLP), comprising:
receiving at least one RLP data frame having a header including a sequence number and a payload, and including an Air Interface Framing Layer (AFL) Info indicator in the header indicating whether the current or future RLP data frames include AFL header information indicating the boundaries of the HLP; and
in response to the AFL Info indicator and the AFL header information, assembling the received data into a HLP, and passing the HLP to a higher layer protocol.

25. The method of claim 24 further comprising entering an ON mode in response to a first value of the AFL Info indicator wherein the receiver extracts AFL header information from every succeeding RLP data frame.

26. The method of claim 24 further comprising entering an OFF mode in response to a second value of the AFL Info indicator wherein the receiver extracts AFL header information only from the RLP data frame with an AFL Info indicator, and appends data extracted from each succeeding RLP data frame to assemble a HLP.

27. The method of claim 26 wherein the receiver terminates assembly of a HLP in response to receiving an RLP data frame with an AFL Info indicator, and including AFL header information.

28. The method of claim 24 further comprising receiving one or more Multiplexing Sublayer Protocol Data Units (MuxPDU) and extracting the RLP data frames from the MuxPDUs.

29. The method of claim 24 further comprising assembling the received data into a Frame Check Sequence Protocol Data Unit (FCS PDU), and decapsulating the HLP from the FCS PDU.

30. The method of claim 29 further comprising examining an FCS field of the FCS PDU and determining whether the FCS PDU has been received without error.

31. The method of claim 29 further comprising decapsulating an Air Interface Framing Protocol Data Unit (AFL PDU) from the FCS PDU, and decapsulating the HLP from the AFL PDU.

32. The method of claim 24 further comprising discarding the HLP if the RLP sequence numbers indicate that part of the HLP was not received.

33. A method of transmitting framing information for Higher Layer Packets (HLP) in a wireless communication network, comprising:
inspecting the HLP;
selecting one of HDLC, BCMCS, RLP control framing assistance, and RLP data framing assistance as a framing information transmission protocol in response to one or more properties of the HLP;
encapsulating the HLP according to the selected protocol; and
transmitting the HLP.

34. The method of claim 33 further comprising switching from a first selected framing information transmission protocol to a second framing information transmission protocol in response to one or more properties of the HLP.

35. The method of claim 33 wherein one property of the HLP is packet size.

36. The method of claim 33 wherein one property of the HLP is data rate.

37. The method of claim 33 further comprising:
detecting the available bandwidth of one or more channels in the wireless communication network; and
selecting the framing information transmission protocol in response to the available bandwidth as well as the HLP properties.

38. A method of transmitting a plurality of Higher Layer Packets (HLP) in a wireless communication network utilizing the Radio Link Protocol (RLP), comprising:
inspecting the HLP;
encapsulating a first HLP into RLP data frames using one of RLP control framing assistance or RLP data framing assistance, in response to one or more properties of the first HLP;
transmitting RLP data frames to a receiver;
encapsulating a second HLP into RLP data frames using the other of RLP control framing assistance or RLP data framing assistance, in response to one or more properties of the second HLP; and
transmitting RLP data frames to a receiver.

39. The method of claim 38 wherein a property of the first HLP is large packet size, and wherein the first HLP is encapsulated using RLP control framing assistance.

40. The method of claim 38 wherein a property of the second HLP is small packet size, and wherein the second HLP is encapsulated using RLP data framing assistance.
